(19) United States
(12) Patent Application Publication
(10) Pub. No.: US 2018/0202208 A1
(43) Pub. Date: Jul. 19, 2018

(54) HINGE

(71) Applicant: VTS SPOLKA Z OGRANICZONA ODPOWIEDZIALNOSCIA, Gdansk (PL)

(72) Inventor: Tadeusz Siek, Suchy Dwor (PL)

(21) Appl. No.: 15/745,332

(22) PCT Filed: Apr. 14, 2016
(86) PCT No.: PCT/PL2016/050011

§ 371 Date: Jan. 16, 2018

(30) Foreign Application Priority Data
Jul. 14, 2015 (PL) P.413125

(51) Int. Cl. E05D 11/10; E05D 3/02; E05D 5/14

(52) U.S. Cl. CPC E05D 11/1014; E05D 2005/106; E05D 5/14; E05D 3/022

(57) ABSTRACT

The hinge comprising at least one leaf part mounted to a movable leaf and equipped with at least one hinge axle or seat and at least one frame part mounted to immovable frame and equipped with at least one seat or hinge axle characterized in that the hinge axle (6) has a cross-sectional mushroom shape inscribed in a circle, a seat (7) has a cylindrical shape with the longitudinal channel and the channel shape corresponds to the shape of the stem of mushroom-shaped hinge axle (6) and the radius of the cylindrical seat (7) corresponds to the radius of the circle described on the mushroom-shaped hinge axle (6).

The present invention relates to a hinge. It is suitable for different uses as an element connecting the movable door leaf with a frame surrounding an opening, which is closed by the door leaf. In particular, the invention is designed for doors of air conditioning or ventilation units and other similar structures.

There are number of known hinges of different structures, in which the construction of the individual elements is adapted to a special functions or applications. The rotatable axle mounted in the support structures, wherein they are formed in the components fixed to the elements that are to be pivotally connected one another, in particular frame, subframe and alike, surrounding the opening and the door leaf closing the opening—eg. doors, windows etc., are the common feature of the majority of hinges. The known hinge constructions are equipped with various types of additional security, regulatory and other features to improve and increase their functionality.

Polish patent specification PL205024 describes a door or window hinge having a frame part and connected thereto pivotally by a rotary bearing axle a leaf part, and equipped with an inclusive a rotary bearing axle seat by a frame part or leaf part flap. Engagement section of the hinge flap is in the space between two posts. The hinge has a horizontal position adjustment device, comprising an adjustment screw in contact with the engagement section of the hinge flap extending into the gap between the frame and the leaf. Between the hinge flap and the frame post there is a plate fastened on the frame post which is pivotally connected with the hinge flap edge. The different variants of construction details, plate connections and other hinge elements are disclosed.

Polish patent specification PL209869 describes a hinge comprising a first hinge member with a hinge element and at least one second hinge member with a hinge element, a bolt inserted in hinge elements and, located at least in one part of the hinge, an eccentric device, which has two openings, and two hinge pin elements in respective openings. One of a hinge pin elements is the screw, which is eccentrically located with respect to the rotation axis of the hinge pin. The different variants of shapes, sections and positioning of the openings, bolts and screws are disclosed.

International application WO00/53874 discloses a construction of the hinge having at least one frame part with the hinge element and connected with it, mounted on the front surface of the fixed frame by the fastening element and the leaf part with the hinge element and connected with it, mounted on the front surface of the leaf by the fastening element. The hinge element of the leaf part overlaps the hinge element of the frame part, and the hinge elements are pivotally connected in the overlap region by a pin forming the hinge axle, inserted in the recesses of the hinge elements and carried directly in the recess. The construction comprises a system of filling element stucked in parallel to the hinge pin, located between at least one end of the recess and the pin and containing at least one element which at least substantially fills at least one space between the hinge pin and the end wall.

A simple construction with a small number of components ensures comfortable use, easy operation and which simultaneously performs two functions of the hinge—closing and tightening connection the leaf to the frame are the invention advantages.

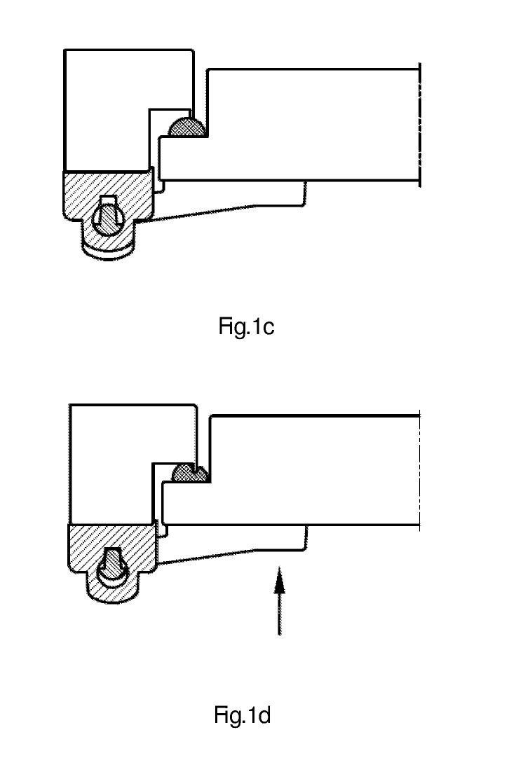

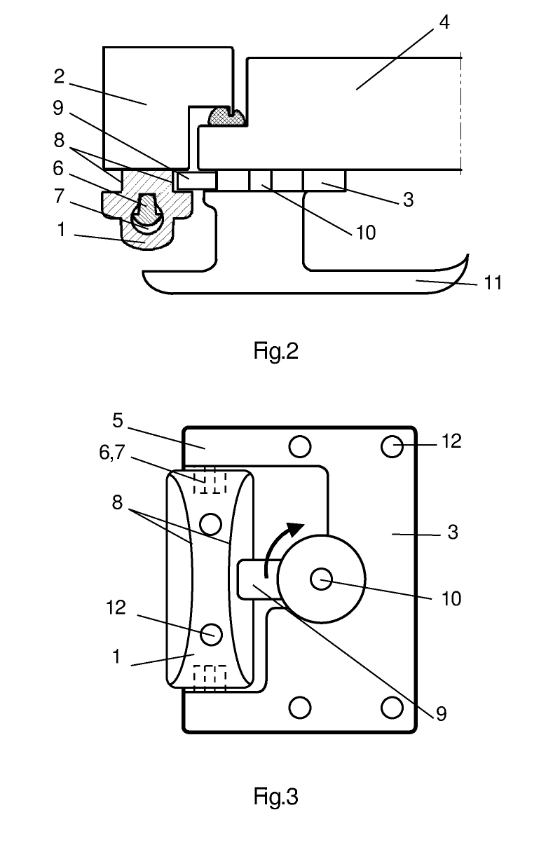

An embodiment of the hinge according to the invention is illustrated in the drawing, in which FIG. I. a, I. b, I. c, I. d are schematic cross-section of the mutual position of the hinge elements in subsequent stages of closing the movable leaf, FIG. 2 shows the hinge in a schematic cross-section the axle and the seat area, and FIG. 3 shows a schematic view of the hinge from the side fixed to the frame and the leaf. In an exemplary embodiment, the hinge is formed from a hard, rigid plastic material and comprises a frame part 1, which is fastened to the fixed frame 2 and the leaf part 3, which is fixed to the movable leaf 4. The leaf part 3 has the form of a flat rectangular body with two arms 5, between which the frame part 1 of the hinge is located, as shown in FIG. 3. Each of the arms 5 on the inner wall from the side of the other arm has the shaped projection forming the hinge axle 6. The frame part 1 is in the form of cuboid body with a with a gutter-shaped convexity in the central region along the outer, longer wall, parallel to the plane of the frame 2. At the two opposite ends of the body of frame part 1 the seats 7 are formed, in which the hinge axles 6 of the leaf part 3 are inserted. In an exemplary embodiment, the hinge has two hinge axles 6, one on each of the arms 5 of the leaf part 3 and two corresponding seats 7, one on the each side of the frame part 1. The hinge axles 6 are cross-sectional mushroom shape inscribed in a circle whose radius is equal to the radius of the arc of the mushroom cap and seats 7 have a corresponding cylindrical shape with the shaped projection forming a longitudinal channel, whose shape corresponds to the shape of mushroom stem of the axle 6. The hinge axles 6 and their seats 7 are formed in such a way that the stem of the mushroom-shaped axle 6 and longitudinal channel of the seat 7 are directed towards the walls of the hinge adjacent to the side of the frame 2 and the leaf 4 to which the hinge is attached.

Cylindrical part of the seat 7 has a radius corresponding to the radius of the arc of a mushroom cap of hinge axle 6 so that the cap could freely rotate in the cylindrical part of the seat. The hinge is also equipped with a blocking device, which is used to immobilize the hinge axle 6 in the seats 7 in the predetermined position. In the exemplary embodiment, the blocking device comprises: arcuate recess 8 formed on the side of the frame 2 in the side wall of the body frame part 1 parallel to the longitudinal axis of the seats 7 and the movable member 9 mounted by a rotary coupling 10 to the leaf part 3, in an empty space between the arms 5 in such away that it can be set into the arcuate recess 8 reaching its edge, wherein preferably the height of this element corresponds to the height of the recess 8 in the frame part 1. Rotation of the movable element can be realized in particular by means of a handle 11 attached to this element at its axis of rotation, from the outside of the hinge. The frame part 1 and a leaf part of the hinge 3 are attached respectively to the frame 2 and the leaf 4 with screws, not shown in the drawing, passing through the assembly holes 12 in the bodies of the frame part 1 and the leaf part 3. In the exemplary embodiment and the in the use of the hinge, frame 2 to which the frame part 1 is fixed, is provided on its periphery with a flange with a sealing fin 13, and the leaf 4, to which a leaf part 3 is fixed, has on its periphery on the side of frame 2 of a resilient seal 14.

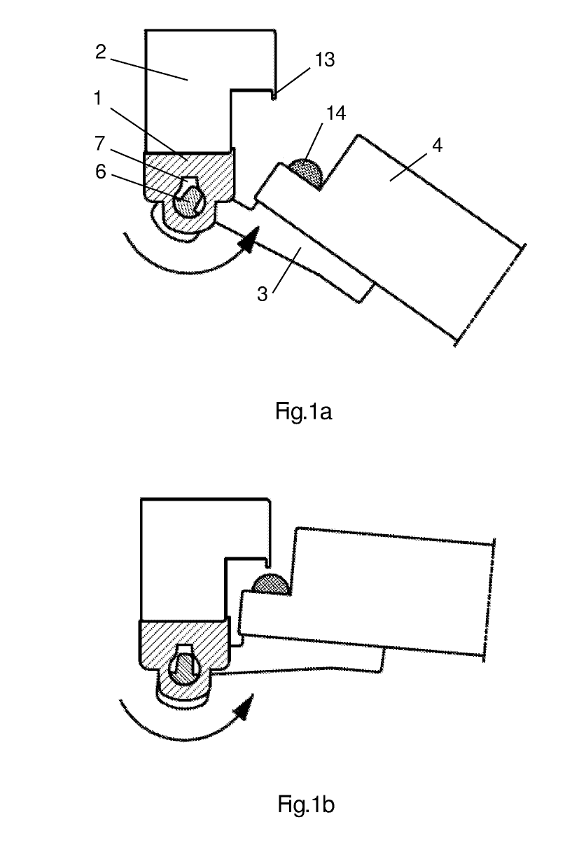

As shown in a FIG. I. a, in an open position of the leaf 4, the heads of the hinge axle 6 rotate freely in the seats 7 of the frame part 1 and the rotation of the leaf 4 in the direction of its closure, as shown in the FIG. I. b, cause the setting of the mushroom stem of the hinge axle 6 in the longitudinal channel of the seats 7, to the closed position, as in the FIG. 1. c, wherein mushroom stems of both hinge axles 6 are aligned precisely with shaped projections of the seats 7 forming longitudinal channels. In the next step, shown in FIG. I. d, linear displacement of the leaf part 3 together with the leaf 4 attached to it, causes the linear displacement of the hinge axle 6 and the setting of the mushroom stem of the hinge axle 6 to the longitudinal channels of the seats 7, whereby the seal 14 of the leaf 4 is clamped to a fi n sealer 13 of the frame 2, which provides a labyrinth seal of the leaf and the frame. The dimensions of the components are established so, that during the process of closing of the leaf 4 its seal 14 passes the fin sealer 13 of the frame 2 and allows collision-free closing, and tightening the seal 14 and the fin seal comes only after the setting of the mushroom stem of the hinge axle 6 in the longitudinal channel of the seat 7. In order to block the leaf in this position the movable element 9 rotates with the handle 11 to the position where it is in the arcuate regress 8 of the body part of the frame part 1, parallel to the arms 5 of the leaf part 3, which fixes the axles of the hinge 6 and prevents slipping the mushroom stem of each hinge axle 6 of the longitudinal channel of the seat 7. In order to facilitate manipulation of the movable element 9 and the safe closure, leaf part 3 is formed between the arms 5 asymmetrically in such away that the rotation of this element can be obtained only through an angle of 90° from the vertical to the horizontal position. The blocking device can be realized by any other technical means ensuring an immobilization the axles in the seats after the mushroom stem of the axle 6 to the longitudinal channel of the seat 7. In various embodiments of the hinge a different number and configuration of frame parts 1, the leaf parts 3, and a different number of hinge axles 6 and seats 7 may be. There is a possibility to put the blocking device into practice by any other technical means which will be function immobilizing the hinge axle in the predetermined position in the seat. A common feature of all variant embodiments remains the shape of the hinge axle and the shape of its seat.

1. The hinge comprising at least one leaf part mounted to a movable leaf and equipped with at least one hinge axle or seat and at least one frame part mounted to immovable frame and equipped with at least one seat or hinge axle characterized in that the hinge axle has a cross-sectional mushroom shape inscribed in a circle, a seat has a cylindrical shape with the longitudinal channel and the channel shape corresponds to the shape of the stem of mushroom-shaped hinge axle and the radius of the cylindrical seat corresponds to the radius of the circle described on the mushroom-shaped hinge axle.

2. The hinge according to claim 1 characterized in that it is provided with a blocking unit for fixing the hinge axle in the seat.

3. The hinge according to claim 2 characterized in that the leaf part has two arms between which there is a body forming a frame part, in which on both sides from the side arms of the leaf part seats are formed, in which the hinge axles extending from the arms are mounted.

4. The hinge according to claim 3 characterized in that the seat channel and the mushroom-shaped hinge axle are directed towards the adjoining walls of the hinge to the frame and the leaf.

5. The hinge according to claim 4 characterized in that the locking unit comprises: the arcuate recess in the body forming the frame part from the side of frame and the movable element fixed to the leaf part between its arms inserted in the arcuate recess.
